(19) United States
(12) Patent Application Publication
(10) Pub. No.: US 2014/0284845 A1
(43) Pub. Date: Sep. 25, 2014

(54) Motor Water-Cooling Structure and Manufacturing Method Thereof

(71) Applicant: Asia Vital Components Co., Ltd., New Taipei City (TW)

(72) Inventor: Sung-Wei Lee, New Taipei City (TW)

(21) Appl. No.: 14/297,239

(22) Filed: Jun. 5, 2014

Related U.S. Application Data
(62) Division of application No. 13/034,703, filed on Feb. 25, 2011.

(51) Int. Cl. B29C 39/10; B29C 45/14

(52) U.S. Cl. CPC B29C 39/10; B29C 45/14065
USPC 264/275

(57) ABSTRACT

A motor water-cooling structure and a manufacturing method thereof are disclosed. The motor water-cooling structure includes a motor case having a wall portion and a tube. The tube is embedded in the wall portion to serve as a flow passage. To manufacture the motor water-cooling structure, the tube is positioned in a mold cavity of a mold, and the motor case is formed in the mold by pour molding to embed the tube therein, so that the motor case and the tube form an integral body. With the manufacturing method, the motor water-cooling structure can be formed with reduced material, labor and time to save the manufacturing costs, and the risk of water leakage can be avoided.

This application claims the priority benefit of Taiwan patent application number 100102805 filed on Jan. 26, 2011.

### FIELD OF THE INVENTION

The present invention relates to a motor water-cooling structure and a manufacturing method thereof; and more particularly to a motor water-cooling structure that includes a motor case formed of one or more types of materials, and a tube embedded in the motor case to serve as a water passage, so as to reduce the manufacturing cost and avoid the risk of water leakage.

### BACKGROUND OF THE INVENTION

A motor is a prerequisite machine for energy conversion. There are motors that convert electric energy into kinetic energy, such as the motors for fans, water pumps and the like. There are also motors that convert kinetic energy into electric energy, such as power generators. Most of the currently available motors are used for the above-mentioned applications. Either the motors for converting electric energy into kinetic energy or the motors for converting kinetic energy into electric energy, they all include stators or rotors that would produce heat during operation thereof. When the produced heat is too high or largely accumulated in the motor, it would have adverse influence on the working efficiency of the motor. In some worse conditions, the motor might become burnt out due to excessive heat produced by the stator or the rotor and accumulated in the motor.

In some conventional ways for overcoming the above problem, holes are formed on a motor case to allow convection of air inside and outside the motor case, so that the heat produced by the motor during operation thereof is dissipated via air cooling. However, air cooling appears to have only limited effect in removing the produced heat from the motor. And, foreign matters, moisture and solutions tend to invasion into an interior of the motor via the holes formed on the motor case to cause damage to the stator and the rotor. Therefore, it is necessary to improve the conventional air cooling structure for motors.

There are also manufacturers who try to remove the internally produced heat from the motor by water cooling. To do so, a groove is formed on an outer side of a motor case to spirally extend in an axial direction of the motor case, and an enclosure is provided to cover the outer side of the motor case and the groove formed thereon, so that the groove forms a water passage in between the motor case and the enclosure. While the water cooling largely improves the heat dissipation of the motor, it also brings other problems to the motor. That is, in the case the motor case and the enclosure are fabricated with insufficient precision, or in the event the material for forming the motor case and the enclosure become oxidized or corroded, cooling water flowing through the water passage tends to leak out of the groove. Further, the forming of the groove on the motor case and the production of the enclosure with highly accurate dimensions are complicated and time consuming to inevitably increase the manufacturing cost of the motor.

In brief, the conventional water-cooling structure for motors has the following disadvantages: (1) requiring complicated fabricating processes; (2) requiring relatively high manufacturing costs; and (3) being subject to water leakage.

### SUMMARY OF THE INVENTION

A primary object of the present invention is to provide a motor water-cooling structure capable of preventing leakage of water therefrom.

Another object of the present invention is to provide a method of manufacturing motor water-cooling structure that enables reduced manufacturing cost of a motor water-cooling structure.

To achieve the above and other objects, the motor water-cooling structure according to the present invention includes a motor case having a wall portion and a tube. The wall portion has an inner side and an outer side, and the tube has an outlet, an inlet, and a tube body. The tube body is embedded in the motor case while the outlet and the inlet are exposed from the outer side of the motor case.

To achieve the above and other objects, the method of manufacturing motor water-cooling structure according to an embodiment of the present invention includes the following steps:

providing a mold having a mold cavity and a tube; and

positioning the tube in the mold cavity of the mold, and forming a motor case in the mold by pour molding to embed the tube in the motor case.

To achieve the above and other objects, the method of manufacturing motor water-cooling structure according to another embodiment of the present invention includes the following steps:

providing a mold having a mold cavity, a first motor case, and a tube; and

winding the tube around an outer side of the first motor case; positioning the first motor case having the tube wound therearound in the mold cavity of the mold; and forming a second motor case on the outer side of the first motor case to cover the first motor case and the tube, so that the second motor case, the first motor case, and the tube form an integral body.

To achieve the above and other objects, the method of manufacturing motor water-cooling structure according to a further embodiment of the present invention includes the following steps:

providing a mold having a mold cavity, a first motor case having a groove provided on an outer side thereof, and a tube; and

setting the tube in the groove on the outer side of the first motor case, positioning the first motor case having the tube set in the groove in the mold cavity of the mold, and forming a second motor case on the outer side of the first motor case to cover the first motor case and the tube, so that the second motor case, the first motor case and the tube form an integral body.

With the present invention, the motor case for the motor water-cooling structure can be formed with one or more types of materials and the tube embedded in the motor case may can serve as a water passage, enabling the motor water-cooling structure to be manufactured at reduced material, labor and time costs, and to avoid the risk of water leakage. Therefore, the present invention has the following advantages: (1) saving the manufacturing cost; and (2) avoiding the risk of water leakage.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a motor water-cooling structure of the present invention according to a first embodiment thereof;

FIG. 2 is a sectioned perspective view of the motor water-cooling structure of FIG. 1;

FIG. 3 is a perspective view of a motor water-cooling structure of the present invention according to a second embodiment thereof;

FIG. 3a is a sectioned perspective view of the motor water-cooling structure of FIG. 3;

FIG. 4 is a sectioned perspective view of a motor water-cooling structure of the present invention according to a third embodiment thereof;

FIG. 4a is a sectioned perspective view of a first part of a wall portion of the motor water-cooling structure of FIG. 4;

FIG. 5 is a flowchart showing the steps included in a first embodiment of a method of manufacturing a motor water-cooling structure according to the present invention;

FIGS. 6 and 7 illustrate the manufacturing method of the present invention according to the first embodiment thereof;

FIGS. 8 and 9 illustrate the manufacturing method of the present invention according to a second embodiment thereof;

FIG. 10 is a flowchart showing the steps included in a third embodiment of the method of manufacturing a motor water-cooling structure according to the present invention;

FIGS. 11 and 12 illustrate the manufacturing method of the present invention according to the third embodiment thereof;

FIGS. 13 and 14 illustrate the manufacturing method of the present invention according to a fourth embodiment thereof;

FIG. 15 is a flowchart showing the steps included in a fifth embodiment of the method of manufacturing a motor water-cooling structure according to the present invention;

FIGS. 16 and 17 illustrate the manufacturing method of the present invention according to the fifth embodiment thereof; and

FIGS. 18 and 19 illustrate the manufacturing method of the present invention according to a sixth embodiment thereof.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

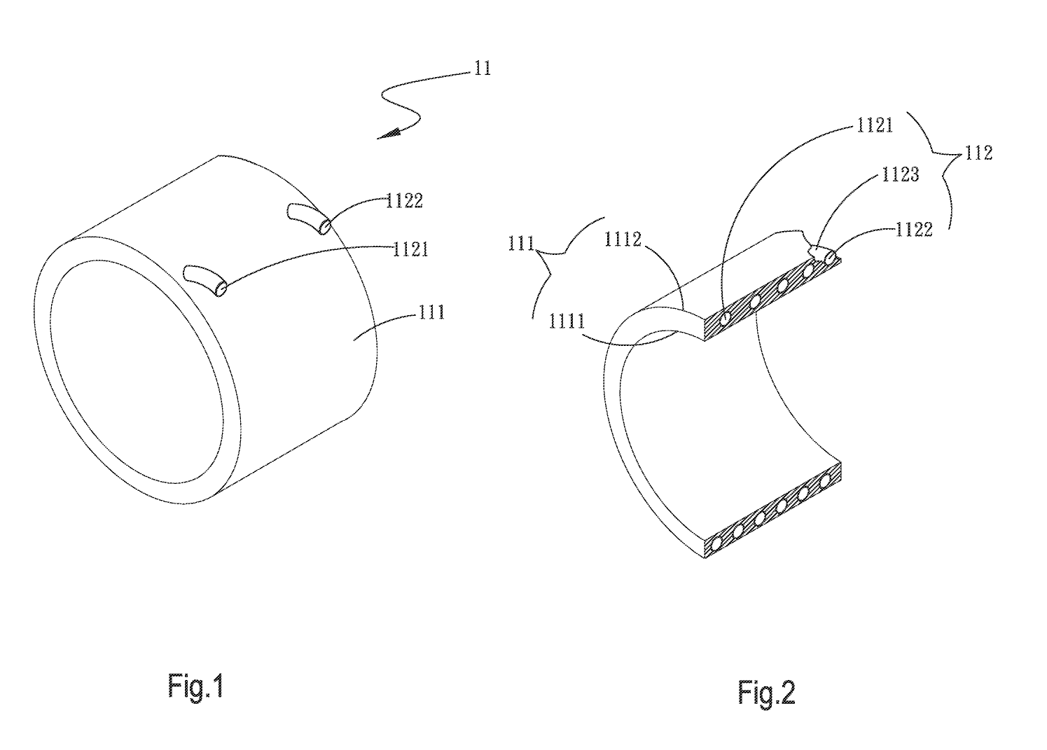

Please refer to FIGS. 1 and 2 that are perspective and sectioned perspective views, respectively, of a motor water-cooling structure of the present invention according to a first embodiment thereof. As shown, the motor water-cooling structure in the first embodiment includes a motor case 11 having a wall portion 111 and a tube 112. The wall portion 111 has an inner side 1111 and an outer side 1112. The tube 112 has an outlet 1121, an inlet 1122, and a tube body 1123. The tube body 1123 is embedded in the wall portion 111 while the outlet 1121 and the inlet 1122 are exposed from the outer side 1112 of the wall portion 111.

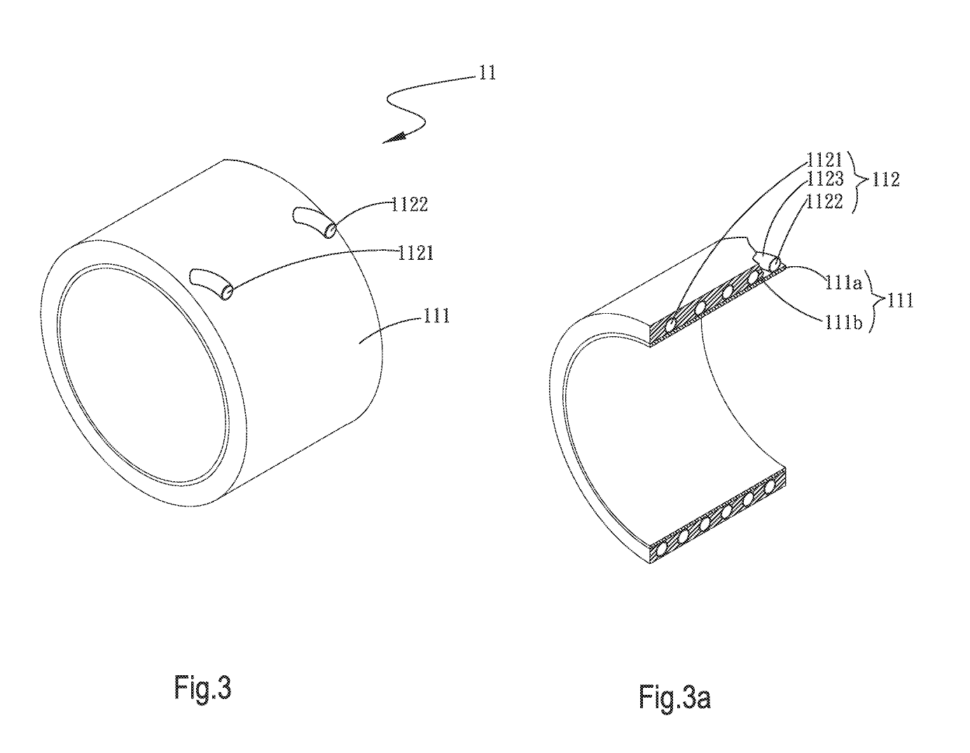

Please refer to FIGS. 3 and 3a that are perspective and sectioned perspective views, respectively, of the motor water-cooling structure of the present invention according to a second embodiment thereof. As shown, the motor water-cooling structure in the second embodiment is generally structurally similar to the first embodiment, except that the wall portion 111 in the second embodiment includes a first part 111a and a second part 111b located outside the first part 111a, as well as the tube 112.

The first part 111a and the second part 111b are in contact with and connected to each other with the tube body 1123 of the tube 112 embedded in between the first part 111a and the second part 111b of the wall portion 111. And, the outlet 1121 and the inlet 1122 of the tube 112 are exposed from an outer side of the second part 111b.

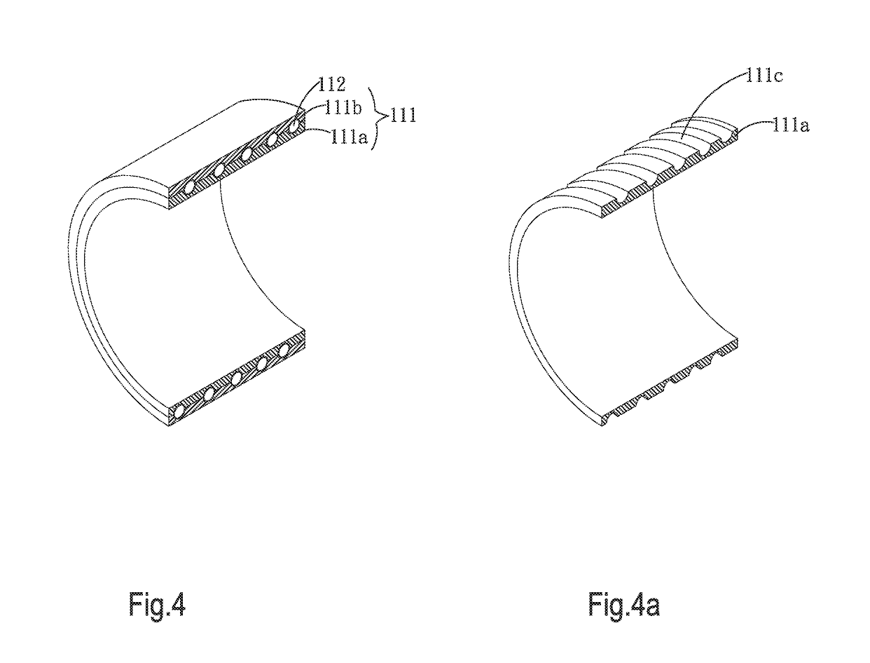

Please refer to FIGS. 4 and 4a. FIG. 4 is a sectioned perspective view of the motor water-cooling structure of the present invention according to a third embodiment thereof; and FIG. 4a is a sectioned perspective view of a first part of the wall portion of the motor water-cooling structure of FIG. 4. As shown, the motor water-cooling structure in the third embodiment is generally structurally similar to the second embodiment, except that the first part 111a of the wall portion 111 in the third embodiment is formed on an outer side facing toward the second part 111b with at least one groove 111 c, which is spirally extended in an axial direction of the first part 111a of the wall portion 111 with the tube 112 set therein. When the second part 111b and the first part 111a of the wall portion 111 are connected to each other, the tube 112 set in the groove 111c is sandwiched between the first and the second part 111a, 111b.

In the above-described second and third embodiments, the first part 111a and the second part 111b of the wall portion 111 as well as the tube 112 can be made of a metal material or a non-metal material. In the case of a metal material, the material can be any one of a copper material, an aluminum material, a stainless steel material, and any other metal materials. And, in the case of a non-metal material, the material can be a plastic material.

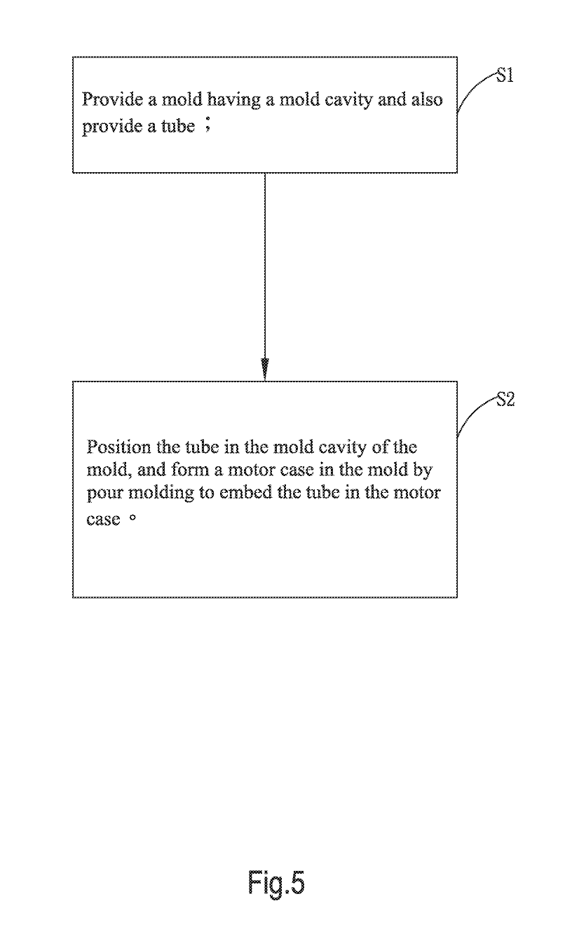

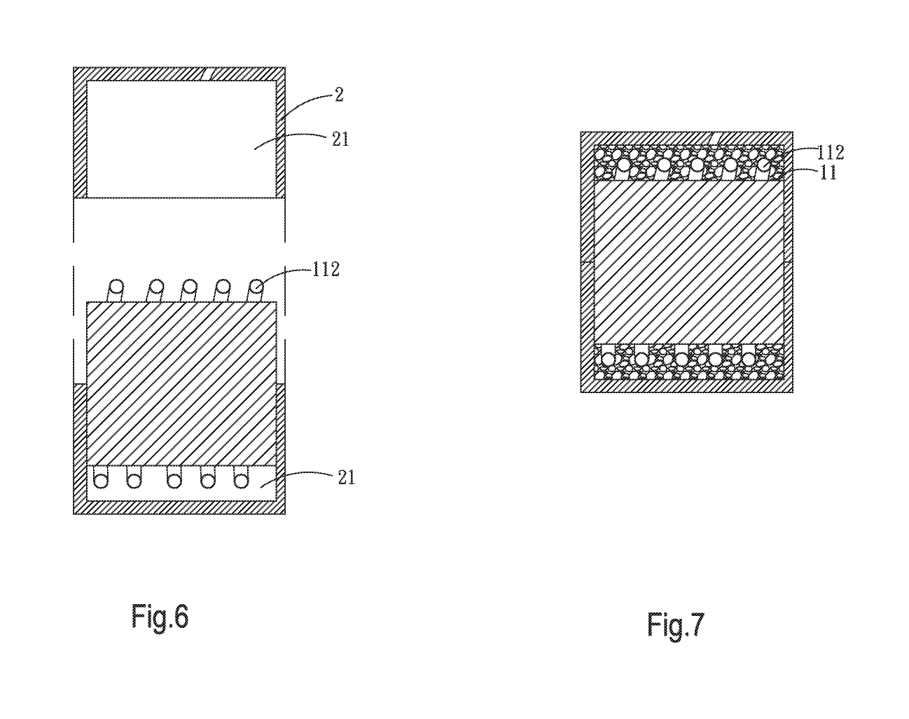

FIG. 5 is a flowchart showing the steps included in a first embodiment of a method according to the present invention for manufacturing a motor water-cooling structure; and FIGS. 6 and 7 illustrate the manufacturing method in the first embodiment thereof. Please refer to FIGS. 5, 6 and 7 along with FIGS. 1 and 2.

In a first step S1 according to the first embodiment of the manufacturing method, a mold having a mold cavity and a tube are provided.

More specifically, as can be seen from FIGS. 6 and 7, a mold 2 having a mold cavity 21 is provided. The mold cavity 21 is dimensioned corresponding to a motor case that is to be formed, such as the motor case 11 shown in FIGS. 1 and 2. And, a tube, such as the tube 112 shown in FIGS. 1 and 2, is also provided.

Then, in a second step S2, the tube is positioned in the mold cavity of the mold, and a motor case is formed by pour molding to embed the tube therein.

More specifically, as can be seen from FIGS. 6 and 7, the tube 112 is positioned in the mold cavity 21 of the mold 2, and a motor case, e.g. the motor case 11, is formed by injection molding a plastic material or a metal material in the mold 2, so that the tube 112 is embedded in the motor case (e.g. the motor case 11) to serve as a flow passage in the molded motor case 11.

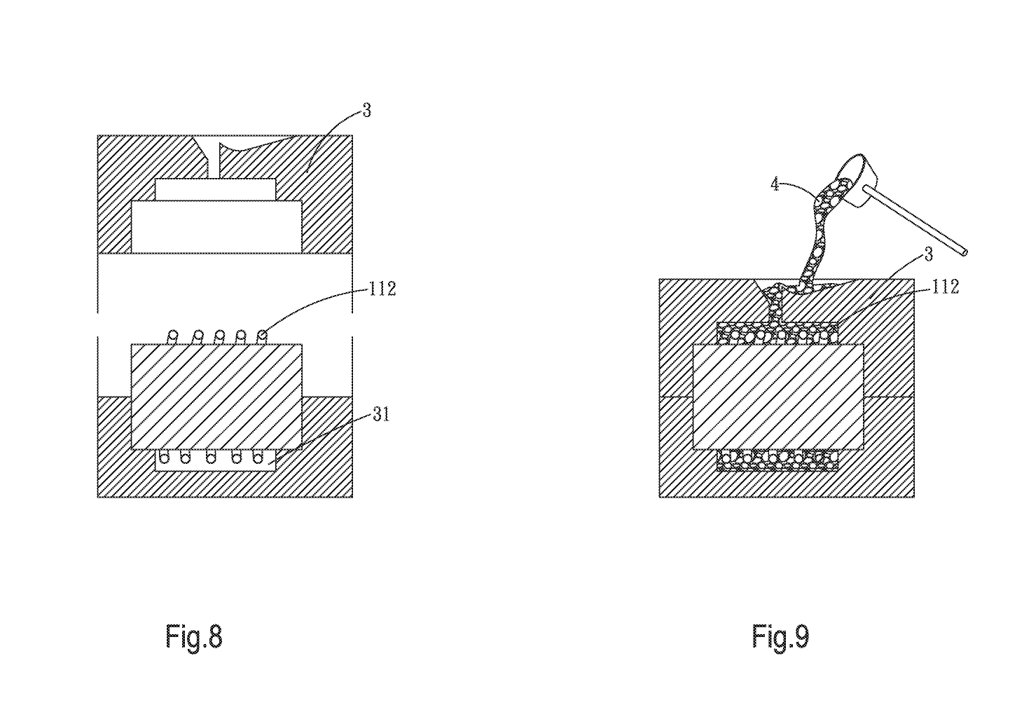

FIG. 5 also shows the steps included in a second embodiment of the method according to the present invention for manufacturing a motor water-cooling structure; and FIGS. 8 and 9 illustrate the manufacturing method in the second embodiment thereof. Please refer to FIGS. 5, 8 and 9 along with FIGS. 1 and 2.

A first step S1 according to the second embodiment of the manufacturing method is the same as that in the first embodiment and is therefore not repeatedly described.

Then, in a second step S2, which is different from that in the first embodiment, the tube is positioned in the mold cavity of the mold, and a motor case is formed by pour molding to embed the tube therein.

More specifically, as can be seen from FIGS. 8 and 9, the tube 112 is positioned in a mold cavity 31 of a casting mold 3, and a motor case, e.g. the case 11, is cast by pouring a molten metal material 4 into the mold cavity 31 of the casting mold 3, so that the tube 112 is embedded in the cast motor case (e.g. the motor case 11) to serve as a flow passage in the cast motor case 11.

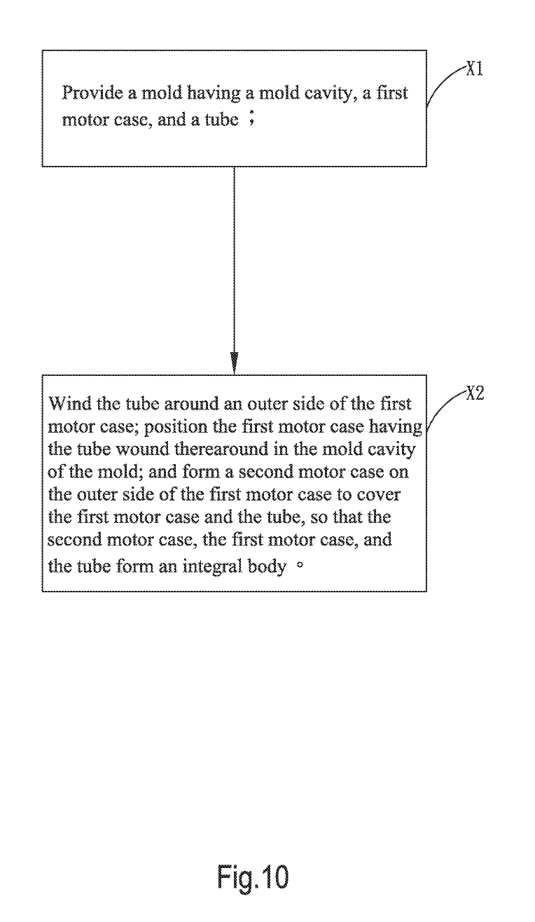

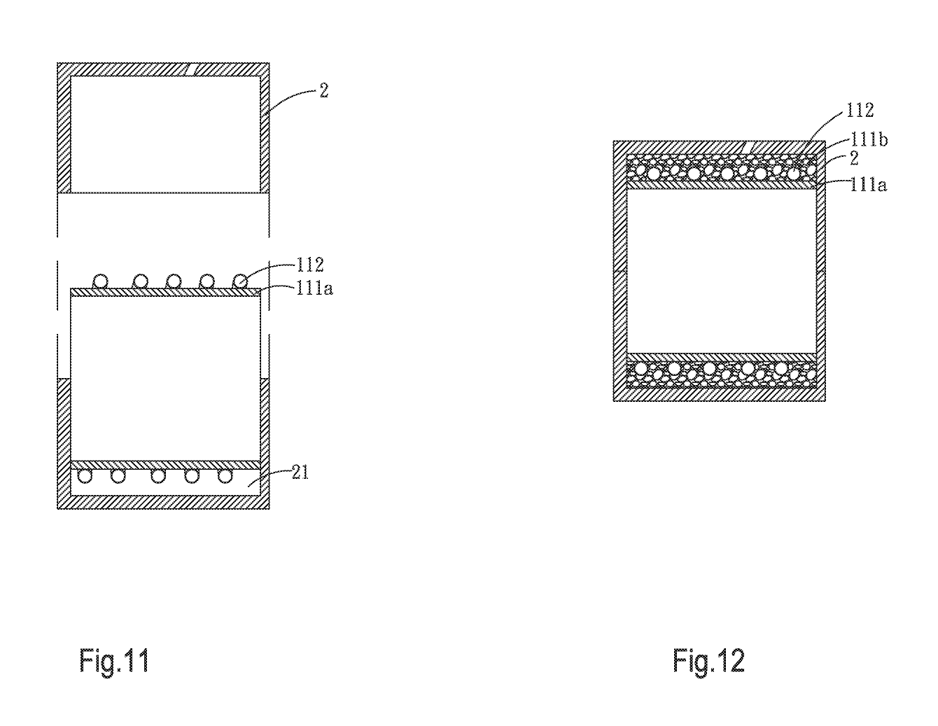

FIG. 10 is a flowchart showing the steps included in a third embodiment of the method according to the present invention for manufacturing a motor water-cooling structure; and FIGS. 11 and 12 illustrate the manufacturing method in the third embodiment thereof. Please refer to FIGS. 10, 11 and 12 along with FIGS. 3 and 3a.

In a first step X1 according to the third embodiment of the manufacturing method, a mold having a mold cavity, a first motor case, and a tube are provided.

More specifically, as can be seen from FIGS. 11 and 12, a mold 2 having a mold cavity 21 is provided. And, a first motor case, such as the first part 111a shown in FIGS. 3 and 3a, and a tube, such as the tube 112 shown in FIGS. 3 and 3a, are also provided.

Then, in a second step X2, the tube is wound around an outer side of the first motor case, and the first motor case with the tube wound therearound is positioned in the mold cavity of the mold; and a second motor case is formed on an outer side of the first motor case to cover the first motor case and the tube, so that the second motor case, the first motor case and the tube form an integral body.

More specifically, as can be seen from FIGS. 11 and 12, the tube 112 is wound around the outer side of the first motor case (e.g. the first part 111a), and the first motor case with the tube 112 wound therearound is positioned in the mold cavity 21 of the mold 2; and a second motor case, e.g. the second part 111b shown in FIGS. 3 and 3a, is formed on an outer side of the first motor case (e.g. the first part 111a) by injection molding a plastic material or a metal material in the mold 2 to cover the first motor case (e.g. the first part 111a) and the tube 112, so that the second motor case (e.g. the second part 111b), the first motor case (e.g. the first part 111a), and the tube (e.g. the tube 112) form an integral body.

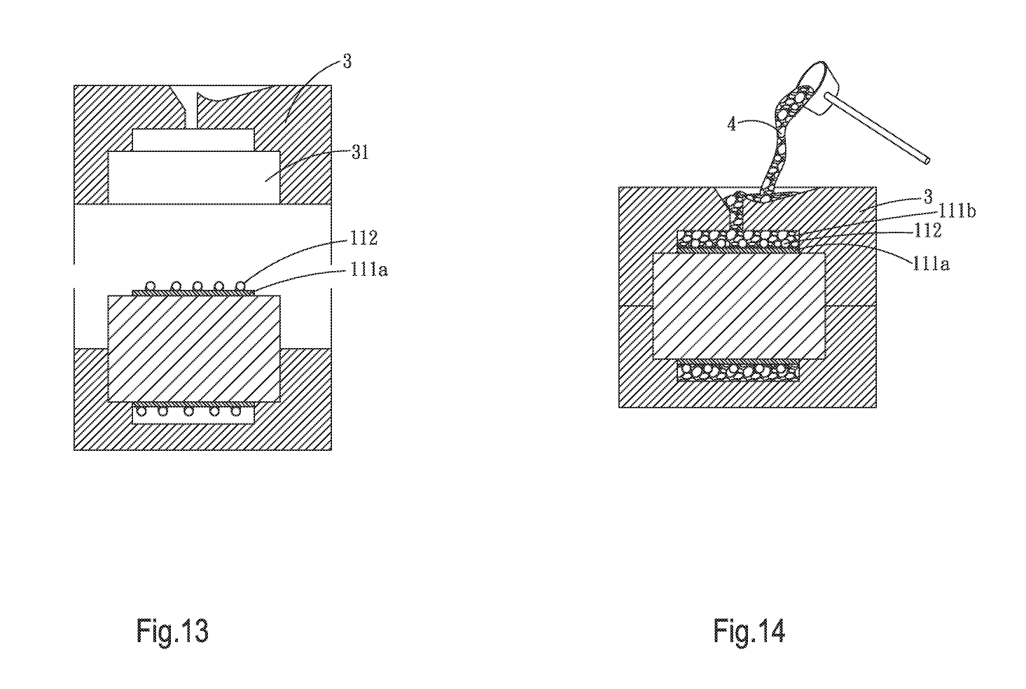

FIG. 10 also shows the steps included in a fourth embodiment of the method according to the present invention for manufacturing a motor water-cooling structure; and FIGS. 13 and 14 illustrate the manufacturing method in the fourth embodiment thereof. Please refer to FIGS. 10, 13 and 14 along with FIGS. 3 and 3a.

A first step X1 according to the fourth embodiment of the manufacturing method is the same as that in the third embodiment and is therefore not repeatedly described.

Then, in a second step X2, which is different from that in the third embodiment, the tube is wound around an outer side of the first motor case, and the first motor case with the tube wound therearound is positioned in the mold cavity of the mold; and a second motor case is formed on an outer side of the first motor case to cover the first motor case and the tube, so that the second motor case, the motor case and the tube form an integral body.

More specifically, as can be seen from FIGS. 13 and 14, the tube (e.g. the tube 112) is wound around the outer side of the first motor case (e.g. the first part 111a), and the first motor case (e.g. the first part 111a) with the tube (e.g. the tube 112) wound therearound is positioned in a mold cavity 31 of a casting mold 3; and a second motor case, e.g. the second part 111b shown in FIGS. 3 and 3a, is cast by pouring a molten metal material 4 into the mold cavity 31 of the casting mold 3 to cover the first motor case (e.g. the first part 111a) and the tube (e.g. the tube 112), so that the second motor case (e.g. the second part 111b), the first motor case (e.g. the first part 111a) and the tube (e.g. the tube 112) form an integral body with the tube (e.g. the tube 112) forming a flow passage in between the first motor case (e.g. the first part 111a) and the second motor case (e.g. the second part 111b).

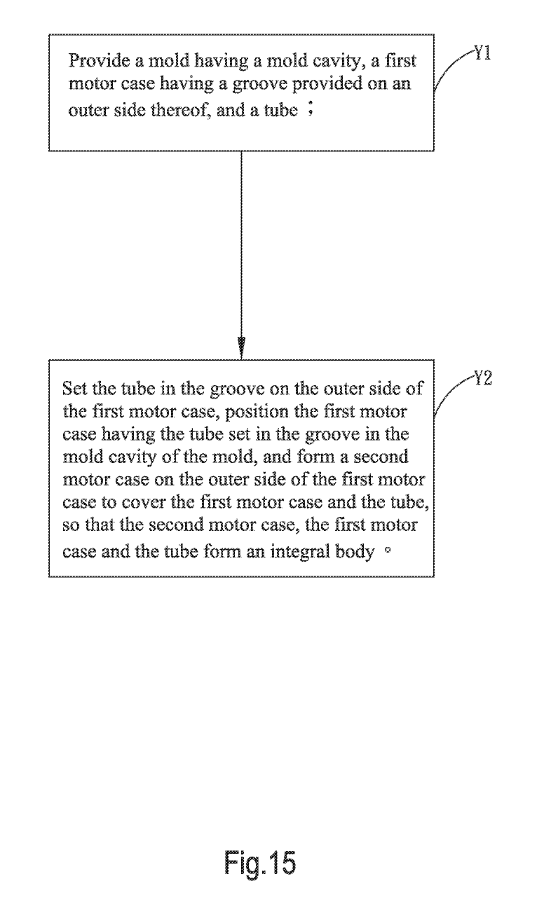

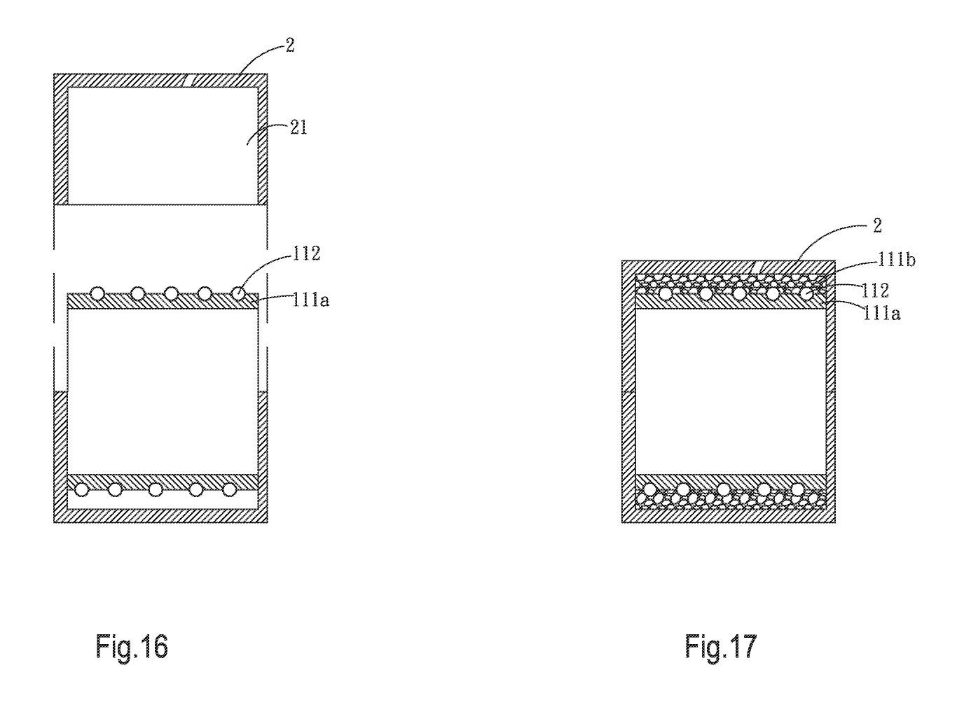

FIG. 15 is a flowchart showing the steps included in a fifth embodiment of the method according to the present invention for manufacturing a motor water-cooling structure; and FIGS. 16 and 17 illustrate the manufacturing method in the fifth embodiment thereof. Please refer to FIGS. 15, 16 and 17 along with FIGS. 4 and 4a.

In a first step Y1 according to the fifth embodiment of the manufacturing method, a mold having a mold cavity, a first motor case having a groove provided on an outer side thereof, and a tube are provided.

More specifically, as can be seen from FIGS. 16 and 17, a mold 2 having a mold cavity 21 is provided. And, a first motor case, such as the first part 111a shown in FIGS. 4 and 4a, having a groove (e.g. the groove 111c) provided on an outer side thereof, and a tube, such as the tube 112 shown in FIGS. 4 and 4a, are also provided.

Then, in a second step Y2, the tube is set in the groove on the outer side of the first motor case, and the first motor case with the tube set in the groove is positioned in the mold cavity of the mold; and a second motor case is formed on an outer side of the first motor case to cover the first motor case and the tube, so that the second motor case, the first motor case and the tube form an integral body.

More specifically, as can be seen from FIGS. 16 and 17, the tube (e.g. the tube 112) is set in the groove (e.g. the groove 111c) formed on the outer side of the first motor case (e.g. the first part 111a), and the first motor case (e.g. the first part 111a) with the tube (e.g. the tube 112) set in the groove is positioned in the mold cavity 21 of the mold 2; and a second motor case, e.g. the second part 111b shown in FIGS. 4 and 4a, is formed on an outer side of the first motor case (e.g. the first part 111a) by injection molding a plastic material or a metal material in the mold 2 to cover the first motor case (e.g. the first part 111a) and the tube (e.g. the tube 112), so that the second motor case (e.g. the second part 111b), the first motor case (e.g. the first part 111a) and the tube (e.g. the tube 112) form an integral body.

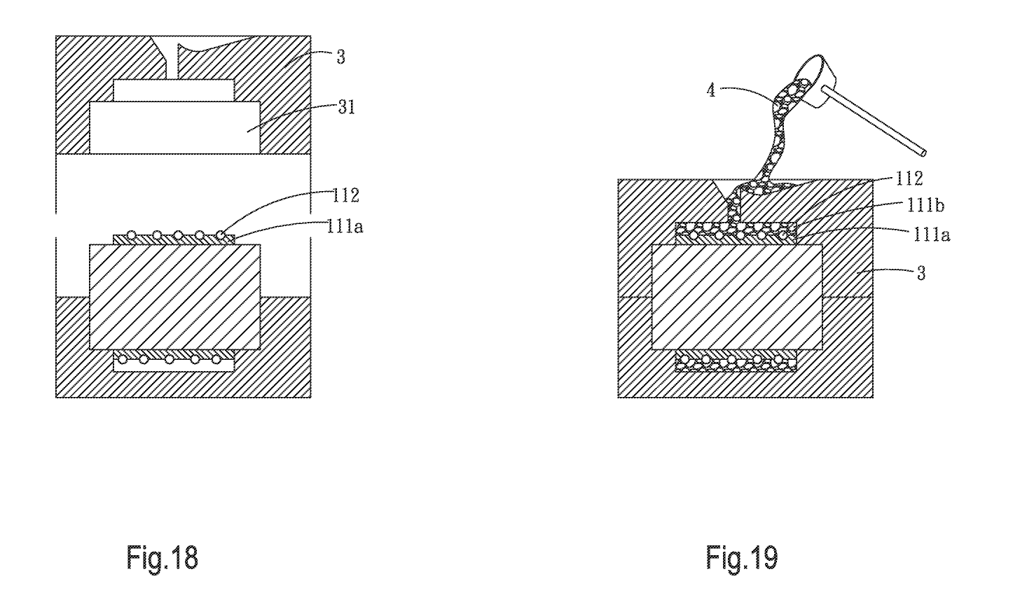

FIG. 15 also shows the steps included in a sixth embodiment of the method according to the present invention for manufacturing a motor water-cooling structure; and FIGS. 18 and 19 illustrate the manufacturing method in the sixth embodiment thereof. Please refer to FIGS. 15, 18 and 19 along with FIGS. 4 and 4a.

A first step Y1 according to the sixth embodiment of the manufacturing method is the same as that in the fifth embodiment and is therefore not repeatedly described.

Then, in a second step Y2, which is different from that in the fifth embodiment, the tube is set in the groove formed on the outer side of the first motor case, and the first motor case with the tube set in the groove is positioned in the mold cavity of the mold; and a second motor case is formed on an outer side of the first motor case to cover the first motor case and the tube, so that the second motor case, the first motor case and the tube form an integral body.

More specifically, as can be seen from FIGS. 18 and 19, the tube (e.g. the tube 112) is set in the groove (e.g. the groove 111c) formed on the outer side of the first motor case (e.g. the first part 111a), and the first motor case (e.g. the first part 111a) with the tube (e.g. the tube 112) set in the groove is positioned in a mold cavity 31 of a casting mold 3; and a second motor case, e.g. the second part 111b shown in FIGS. 4 and 4a, is cast by pouring a molten metal material 4 into the mold cavity 31 of the casting mold 3 to cover the first motor case (e.g. the first part 111a) and the tube (e.g.

the tube 112), so that the second motor case (e.g. the second part 111b), the first motor case (e.g. the first part 111a) and the tube (e.g. the tube 112) form an integral body with the tube (e.g. the tube 112) forming a flow passage in between the first motor case (e.g. the first part 111a) and the second motor case (e.g. the second part 111b).

With the first to the sixth embodiment of the method according to the present invention for manufacturing a motor water-cooling structure, the motor water-cooling structure can be formed with one or more types of materials at reduced material, labor and time costs. Further, a material with relatively high thermal conductivity, such as a copper material, and a material with relatively high heat dissipation efficiency, such as an aluminum material, can be selected for forming the first part and the second part of the motor case, respectively, to embed the tube 112 therebetween by means of insert molding, so as to achieve the object of upgrading the heat dissipation efficiency of the motor water-cooling structure.

Moreover, the use of the tube 112 to replace the water passages for the conventional motor water-cooling structure can not only prevent the risk of water leakage, but also save the time and labor for mechanically forming the water passages on the motor case, and accordingly, enables increased good yield and reduced manufacturing cost of motor water-cooling structure.

The present invention has been described with some preferred embodiments thereof and it is understood that many changes and modifications in the described embodiments can be carried out without departing from the scope and the spirit of the invention that is intended to be limited only by the appended claims.

1-7. (canceled)

8. A method of manufacturing motor water-cooling structure, comprising the following steps: providing a mold having a mold cavity and a tube; and positioning the tube in the mold cavity of the mold, and forming a motor case in the mold by pour molding to embed the tube in the motor case.

9. The manufacturing method as claimed in claim 8, wherein the motor case is formed in a manner selected from the group consisting of injection molding and casting.

10. A method of manufacturing motor water-cooling structure, comprising the following steps: providing a mold having a mold cavity, a first motor case, and a tube; and winding the tube around an outer side of the first motor case; positioning the first motor case having the tube wound therearound in the mold cavity of the mold; and forming a second motor case on the outer side of the first motor case to cover the first motor case and the tube, so that the second motor case, the first motor case, and the tube form an integral body.

11. The manufacturing method as claimed in claim 10, wherein the second motor case is formed on the outer side of the first motor case in a manner selected from the group consisting of injection molding and casting.

12. A method of manufacturing motor water-cooling structure, comprising the following steps: providing a mold having a mold cavity, a first motor case having a groove provided on an outer side thereof, and a tube; and setting the tube in the groove on the outer side of the first motor case, positioning the first motor case having the tube set in the groove in the mold cavity of the mold, and forming a second motor case on the outer side of the first motor case to cover the first motor case and the tube, so that the second motor case, the first motor case and the tube form an integral body.

13. The manufacturing method as claimed in claim 12, wherein the second motor case is formed on the outer side of the first motor case in a manner selected from the group consisting of injection molding and casting.
